(19) United States
(12) Patent Application Publication
(10) Pub. No.: US 2025/0158285 A1
(43) Pub. Date: May 15, 2025

(54) WAVEGUIDE POLARIZER, CONTACTLESS SIGNAL TRANSMISSION SYSTEM AND ANTENNA DEVICE COMPRISING THE WAVEGUIDE POLARIZER

(71) Applicant: SAMSUNG ELECTRONICS CO., LTD., Suwon-si (KR)

(72) Inventors: Anton Sergeevich LUKYANOV, Moscow (RU); Alexander Gennadievich CHERNOKALOV, Moscow (RU); Youngho RYU, Suwon-si (KR); Chongmin LEE, Suwon-si (KR)

(73) Assignee: SAMSUNG ELECTRONICS CO., LTD., Suwon-si (KR)

(21) Appl. No.: 19/027,620

(22) Filed: Jan. 17, 2025

Related U.S. Application Data
(63) Continuation of application No. PCT/KR2024/016108, filed on Oct. 22, 2024.

(30) Foreign Application Priority Data
Oct. 24, 2023 (RU) 2023127278

(51) Int. Cl. H01Q 13/02; B25J 19/00

(52) U.S. Cl. CPC H01Q 13/0266; B25J 19/0045; H01Q 13/0241

(57) ABSTRACT

Provided is a system for contactless signal transmission through a rotary joint including a transmitter on a first part of the rotary joint and a receiver on a second part of the rotary joint, the first and second parts being opposite and separated by an air gap, surfaces of the first and second parts facing each other being perpendicular to a rotation axis of the rotary joint, and a choke in the air gap contacting one of the first and second parts, the choke including a printed circuit board having a through hole coaxial with the rotation axis, and an electromagnetic chip, each of the transmitter and the receiver includes a hollow waveguide, at least the transmitter includes in a waveguide polarizer, a diameter of the waveguide polarizer being smaller than a diameter of the round hollow waveguide, and two longitudinal diametrically opposite grooves in walls of the waveguide polarizer.

### CROSS-REFERENCE TO RELATED APPLICATIONS

This application is a bypass continuation of International Application No. PCT/KR2024/016108, filed on Oct. 22, 2024, which is based on and claims priority to Russian Patent Application No. 2023127278, filed on Oct. 24, 2023, in the Korean Intellectual Property Office, the disclosures of which are incorporated by reference herein in their entireties.

### BACKGROUND

### 1. Field

Embodiments of the present disclosure relate to a rotary joint comprising a waveguide polarizer, and to a contactless signal transmission system and an antenna device comprising said waveguide polarizer.

### 2. Description of Related Art

The rapid growth of robotics technologies is currently based on the growing need for automated and robotic complexes in various areas of human activity, such as the military, industry, mining, etc., in which requires development of structures for transmitting signals to and from actuators of the robotic complex (robot) through parts (joints) of the robot. Such development is especially important for rotating parts, such as rotating robot joints.

At present, there are several ways to organize the transmission of signals through rotary joints.

For example, cable assemblies may be used to transmit signals. In the assemblies, the cable passes through a rotary joint. However, cable assemblies may have a number of disadvantages, including a limited rotation range of the joints, relatively low reliability of the cable due to torque, relatively high probability of cable damaging during intense movements, etc.

Rotary contacts (slip rings) may be used, but rotary contacts are not suitable for high data rates (HD video, etc.), have relatively low reliability, may lead to interference due to sparking between contacts, and degrade with time due to mechanical wear. In addition, mechanical part of the rotary contact may require high-precision manufacture.

High-frequency rotary joints based on split coaxial or round waveguides may also be used. However, high-frequency rotary joints may often have full-metal bulky designs suitable only for stationary objects, and require complex and high-precision assembly. In addition, high-frequency rotary joints may provide only a half-duplex channel connection per line.

The use of circular polarized signals for data transmission may enable full-duplex and multi-channel communication due to its symmetry, and therefore may be used in rotary couplings. The polarizer may more easily provide a circular polarized signal in round waveguide that, due to its symmetry, may allow the efficient propagation of a circular polarized signal.

A microwave rotating coupling for rectangular waveguide for connecting high-frequency components may include an input component and an output component, where each component has a rectangular connecting piece at one end and a round waveguide at the other end. Both components are arranged such that the round waveguides facing each other are rotatably mounted in a coupling transition coaxially about the common axis (A) thereof. The microwave rotating coupling for rectangular waveguide may also include a polarizer, by which at least one linear polarized wave can be transduced to a circular polarized or at least one circular polarized wave can be transduced to a linear polarized wave, is provided between the rectangular connecting piece and circular waveguide. Furthermore, the rectangular connecting pieces are arranged axially to the circular waveguides and at least one rectangular waveguide may be connected in parallel to the axis (A). However, the microwave rotating coupling for rectangular waveguide may have a bulky design.

A dual-band circular polarizer for simultaneously transforming two to four linear polarized waves of two different frequency bands into two to four circular polarized waves, and vice versa may be provided. The polarizer may include a waveguide of circular or square cross-sectional shape dimensioned to simultaneously propagate signals in two different frequency bands and two arrays of conductive elements, each array comprising a pair of diametrically opposed rows of conductive elements extending inwardly from the walls of the waveguide. However, the polarizer may be difficult to manufacture, as may require conductive elements used in the waveguide, and holding elements for dielectric polarizer in waveguide. The dielectric polarizer may introduce additional losses during signal transmission. Moreover, polarizer may only provide half-duplex communication.

Multichannel microwave rotary coupling may include single-channel rotary joints mounted coaxially one above another, each based on a coaxial line with quarter-wave short-circuited loops in the form of a radial line and matching transitions at ends. Outer and central conductors of the coaxial line comprise quarter-wave choke clearances, radial line has variable height, and a hollow metal rod of cylinder shape passes through central conductors of single-channel couplings from rotating to stationary part of the structure, which forms choke clearances with fixed central conductors. Movable inputs of single-channel rotary couplings are brought to the rotating part of the device structure by means of coaxial feeders, passing, except for the feeder of the upper single-channel coupling, through the internal cavity of the rod. The design is bulky and complicated in assembly.

A dual-band dual-polarization splitter to form a new type of coaxial waveguide ortho-mode transition may be provided, and implement the structure of coaxial round waveguide feeding in relatively high and low frequencies at the same time, reducing the length of the high-frequency transmission line, and reducing the transmission loss.

A dual-polarization transmission in each frequency band may be implemented, and may flexibly switch between vertical polarization and horizontal polarization when the dual-polarization has been transduced to the single-polarization. However, such apparatus may have a relatively bulky design and a complicated assembly process.

Therefore, there is a need for a compact, reliable, simple and inexpensive system that provides high-speed and contactless signal transmission, including through rotary joints of robots.

### SUMMARY

One or more embodiments provide a rotary joint comprising a waveguide polarizer, and to a contactless signal transmission system and an antenna device comprising said waveguide polarizer.

According to an aspect of one or more embodiments, there is provided a system for contactless signal transmission through a rotary joint, including a transmitter on a first part of the rotary joint and a receiver on a second part of the rotary joint, the first part of the rotary joint and the second part of the rotary joint being opposite each other and separated by an air gap, a surface of the first part and a surface of the second part facing each other being perpendicular to a rotation axis of the rotary joint, and a choke in the air gap between the first part of the rotary joint and the second part of the rotary joint and contacting one of the first part of the rotary joint and the second part of the rotary joint, the choke including a printed circuit board having a circular through hole coaxial with the rotation axis of the rotary joint, and an electromagnetic chip having an electromagnetic bandgap adjacent to the hole in the printed circuit board, the choke being configured to prevent signal leakage through the air gap, wherein each of the transmitter and the receiver includes a round hollow waveguide aligned with the rotation axis, wherein at least the transmitter may include in a waveguide polarizer which is a portion of the round hollow waveguide, a diameter of the waveguide polarizer being smaller than a diameter of the round hollow waveguide, and wherein two longitudinal diametrically opposite grooves are formed in walls of the waveguide polarizer.

The length of the waveguide polarizer may be a multiple of λ_{g}/2, where λ_{g} is a central wavelength of the signal operating range in the round hollow waveguide.

A bottom surface of the grooves may coincide with inner walls of the round hollow waveguide.

The grooves may extend along an entire length of the waveguide polarizer.

A diameter of the hole in the printed circuit board may be equal to a diameter of the round hollow waveguide in the transmitter and the receiver.

A distance from the hole in the printed circuit board of the choke to the EBG structure may be a multiple of λ/4, where λ is a central wavelength of the signal operating range in a plane-parallel waveguide formed based on surfaces of the first part and the second part and the choke.

The EBG structure may be adjacent to the hole in the printed circuit board of the choke.

The EBG structure may include at least two rows of mushroom-EBG (M-EBG) elements, each M-EBGs including a conductive pad on the outer layer of the printed circuit board, and a cylinder base formed by a metallized via and connecting the conductive pad to a conductive ground layer included in the printed circuit board.

The gap between the choke and each of the first part of the rotary joint and the second part of the rotary joint may be less than or equal to λ/4, where λ is the central wavelength of the signal operating range in a plane-parallel waveguide formed based on the surfaces of first part and the second part and the choke.

The printed circuit board of the choke may include four metallized conductive layers alternately disposed with dielectric layers, and the EBG structure may be on both sides of the printed circuit board.

The M-EBG elements on opposite sides of the printed circuit board may be interconnected by a via.

The choke may be directly on one of the surfaces of the first part and the second part.

The printed circuit board of the choke may include two metallized conductive layers with a dielectric layer between the two metallized conductive layers, and the EBG structure may be on a side of the printed circuit board that is separated by the air gap from the surface of the other part of the surfaces of the first part and the second part, based on electrical contact being provided between a ground layer of the choke and the surface of said one of the rotary joint parts.

The receiver may include a waveguide polarizer in the round waveguide.

The signal may be a data signal for data transmission through the rotary joint.

### BRIEF DESCRIPTION OF DRAWINGS

Embodiments will be more clearly understood from the following detailed description taken in conjunction with the accompanying drawings in which:

FIG. 1 is a cross-sectional view of a rotary joint according to one or more embodiments;

FIG. 2 illustrates the principle of operation of a polarizer according to one or more embodiments;

FIG. 3 is a view of a part of a choke according to one or more embodiments; and

FIG. 4 shows an example design of an electromagnetic band gap (EBG) structure element according to one or more embodiments.

### DETAILED DESCRIPTION

Embodiments are not limited to those described herein, other embodiments that do not go beyond the spirit and scope of the invention will become apparent to the person skilled in the art based on the information set forth in the description and prior art knowledge.

Elements mentioned in the singular do not exclude the plurality of the elements, unless otherwise specifically stated.

In the above description of examples, direction terms (such as “above”, “up”, “below”, “down”, “up”, “down”, etc.) are used only for the convenience of referring to the accompanying drawings.

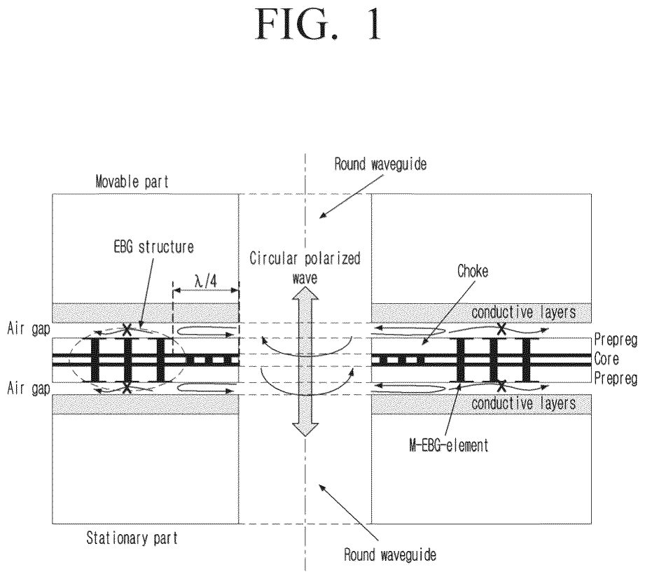

In accordance with an aspect of one or more embodiments, a system is provided for contactless signal transmission through a rotary joint shown in FIG. 1. In terms of mechanical movement, the rotary joint consists of two parts including a stationary part and a movable part. According to one or more embodiments of the rotary joint, the stationary part and movable part may change operations at different times, or simultaneously move relative to each other, for example, act as a movable part. However, for convenience of description, it is assumed that one part of the rotary joint is stationary part and the other part is movable relative to the first part.

In one or more embodiments, the upper part of the joint shown in FIG. 1 is movable and the lower part of the joint is stationary. However, embodiments are not limited thereto, and the joint parts may be inverted. For example, the upper part of the joint may be stationary and the lower part of the joint may be movable. With respect to signal transmission, depending on the direction of transmission, the part of the signal transmission system on the stationary part of the joint may be either a transmitter that may transmit a signal to the other part of the transmission system or a receiver that may receive a signal from the other part of the transmission system. Similarly, the part of the signal transmission system on the joint movable part may be either a transmitter or a receiver. Moreover, when the part of the signal transmission system on the stationary part of the joint is the transmitter, the part of the signal transmission system on the movable part of the joint is the receiver, and vice versa. During the operation, the direction of signal transmission may be repeatedly reversed, for example, respective structures of the signal transmission system may change operations.

A system for contactless signal transmission through a rotary joint according to one or more embodiments may include a transmitter disposed on one part of the rotary joint (e.g. stationary part of the joint) and a receiver disposed in the other part of the rotary joint (e.g. movable part of the joint), the rotary joint parts being opposite each other and separated by an air gap. FIG. 1 shows one or more embodiments of a rotary joint. Surfaces of the stationary part and the movable part that are parallel to each other and perpendicular to the rotation axis of the rotary joint face each other, and a conductive layer is provided on the surfaces. Each of the transmitter and the receiver may include a round hollow waveguide aligned with the rotation axis of the rotary joint. The waveguide in each of the stationary part and the movable part reaches the surface facing the other rotary joint part. Thus, the waveguides in the transmitter and the receiver are coaxially opposite each other and separated by an air gap. Diameter of the round waveguide may be determined for the operation and propagation of H₁₁ mode, and may be less than or equal to the diameter for the operation of higher modes, such as E₀₁ and others.

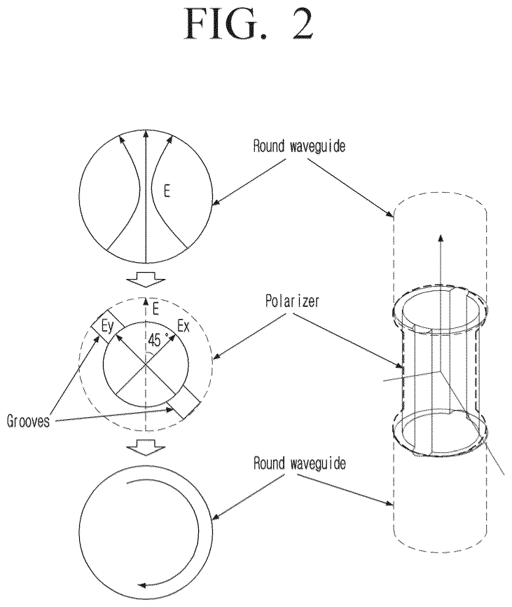

The transmitter may include a grooved round waveguide polarizer disposed in a round waveguide and have the form of a section of the round waveguide. The transmitter may have an internal diameter smaller than a diameter of the waveguide and two longitudinal grooves in walls of the polarizer. The grooves are disposed diametrically opposite to each other along the entire length of the polarizer parallel to the longitudinal axis of the waveguide (see FIG. 2). The polarizer is configured to transduce at least one linear polarized wave to a circular polarized wave, or at least one circular polarized wave to a linear polarized wave.

The polarizer according to one or more embodiments may operate as described below. First, an electromagnetic wave of dominant H₁₁ mode is excited in the round waveguide (see FIG. 2, upper cross-section). The wave may be excited by output of a generator having the appropriate shape of the output waveguide, or by waveguide transitions to cross-sections of coaxial cables. In addition, the wave excitation may be provided by a transition with a radio frequency chip. The polarizer grooves are arranged in the cross-section at an angle of 45 degrees to the incident electromagnetic wave of the dominant H₁₁ mode (see FIG. 2, middle cross-section). The H₁₁ mode is incident on a grooved polarizer at an angle of 45 degrees to said grooves (dotted arrow on the middle cross-section in FIG. 2 is electric vector of H₁₁ mode). In the polarizer, the H₁₁ mode is split into two mode components: Ex and Ey (solid arrows on the middle cross-section in FIG. 2). The Ex component propagates over the polarizer across the grooves, while the other component Ey propagates over the polarizer along the grooves. The Ex component has a propagation constant lower than a propagation constant of the Ey component. Thus, the phase difference between the Ex and Ey components that have passed through the grooves is 90 degrees. Addition of the Ex and Ey components at the polarizer output forms circular polarized H₁₁ mode (semicircular line on the lower cross-section in FIG. 2).

Thus, when passing through the polarizer, the linear polarized electromagnetic wave of the dominant H₁₁ mode (see FIG. 2, upper cross-section) transforms to a circular polarized electromagnetic wave of the dominant H₁₁ mode (see FIG. 2, lower cross-section).

The length of the polarizer is initially chosen as a multiple of λ_{g}/2, where λ_{g} is the central wavelength of the signal operating range in the round waveguide. The length of the polarizer is then adjusted empirically after numerical simulation of the device. Inner diameter of the polarizer depends on the size of the grooves and their characteristics (transverse and longitudinal wave propagation constants). In one or more embodiments, bottom of the grooves coincides with inner walls of the basic hollow waveguide. Thus, the height (depth) of the grooves matches the difference between the inner diameter of the polarizer and the inner diameter of the hollow waveguide. The depth and width of the grooves are set to minimize reflections and losses per signal passage. The H₁₁ mode incident at 45 degrees relative to the grooves is split equally into two components and one component may lag in phase by 90 degrees from the other component. Shape of the grooves may differ from that shown in FIG. 2 that may provide the 90 degrees phase difference and equal splitting of the incident wave components.

Although FIG. 2 shows the formation of a single dominant H₁₁ mode, an orthogonal dominant H₁₁ mode may be also simultaneously formed in the waveguide. When passing through the polarizer, the orthogonal dominant H₁₁ mode is similarly transduced to an opposite circular polarized electromagnetic wave. Thus, the waveguide with the polarizer may simultaneously transmit signals over two independent transmission channels.

Similarly, the polarizer described above may reverse transduce at least one circular polarized wave to a linear polarized wave.

To obtain a signal from a linear polarized wave for transmitting the signal further over the electronic circuit, waveguide transitions may be used to minimize losses for conversion of the waveguide wave into the wave types of subsequent waveguide structures. A microstrip waveguide may be used, which may be connected directly to the receiving or transmitting device (chip).

The polarizer of one or more embodiments may be easier to manufacture, has a more compact design, and may not contain any dielectric parts, which reduces signal transmission losses over a relatively wide frequency range.

In one or more embodiments, a rotary joint may include a polarizer in both the transmitter and receiver, allowing for two-way signal transmission.

According to one or more other embodiments, a polarizer may be included in the transmitter of the contactless signal transmission system to provide a one-way circular polarized signal transmission.

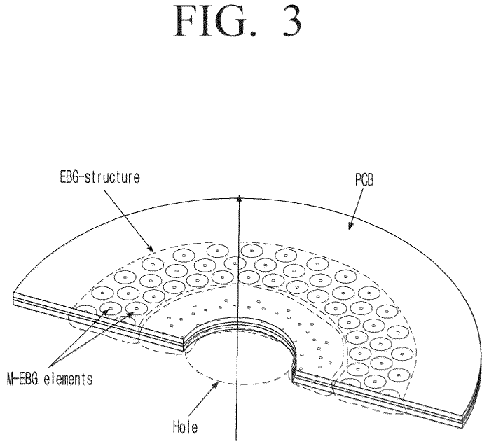

A metamaterial choke may be disposed in the air gap between the stationary and movable parts of the rotary joint to prevent signal (energy) leakage through the air gap (see FIGS. 1 and 3). The choke may include a printed circuit board (PCB) with a through circular hole coaxial with the rotation axis of the rotary joint. A diameter of the hole in the PCB may be consistent with the diameter of the round waveguide in the transmitter and the receiver of the rotary joint. In one or more embodiments of one or more embodiments depicted in FIG. 1, the diameter of the hole in the PCB is equal to the diameter of the round waveguide in the transmitter and receiver of the rotary joint. The PCB according to one or more embodiments may include four metallized conductive layers alternated with dielectric layers. An Electromagnetic Band Gap (EBG) structure in the form of an electromagnetic chip with electromagnetic band gap, for example, a structure forming an area where electromagnetic waves of a certain frequency range may not propagate, is provided in the PCB around the hole and spaced apart from the hole. The EBG structure of one or more embodiments is placed on both sides of the multilayer PCB and may include, on each side, at least two rows of mushroom-shaped EBG (M-EBG) elements. For example, in FIGS. 1 and 3, the EBG structure may include three, however, embodiments are not limited thereto. Each M-EBG element may include a conductive pad placed on the outer layer of the PCB and a cylinder-shaped base formed by a metalized via and connecting the conductive pad to the inner conductive ground layer of the PCB. In the embodiment of FIG. 1, M-EBG elements on opposite sides of the PCB are interconnected through via. The EBG structure blocks surface wave propagation in the PCB and the air gap between the stationary and movable parts of the rotary joint, thus preventing signal (energy) from leaking outwards from the rotary joint.

In one or more other embodiments, where the M-EBG elements on opposite sides of the PCB are not interconnected, additional M-EBG elements may be provided in the resulting gap within the choke PCB.

In some embodiments, the M-EBG elements on opposite sides of the PCB may be offset relative to each other.

The distance between adjacent M-EBG elements in the row may be set to limit the propagation of spurious waves (band gap). Dispersion diagram shows which frequencies the limitation may be achieved. Therefore, distances between the M-EBG elements are determined according to the dispersion diagram of a single element cell and the process capabilities of the PCB manufacturer (limitation on the gaps between conductors). The distance between rows of M-EBG elements and the number of rows are chosen based on the obtained dispersion diagram and the absence of modes in the operating range of the device.

In one or more other embodiments, the choke may have more than four conductive layers, and the EBG structure may have more than two rows of M-EBG elements.

The distance from the edge of the hole in the choke PCB to the EBG structure may be set to ensure a more effective wave reflection and reduce signal transmission loss through the air gap, and may be a multiple of λ/4, where λ is the central wavelength of the signal operating range of the signal transmission system in a plane-parallel waveguide formed by surfaces of the facing each other rotary joint parts and the choke. In one or more embodiments, the EBG structure is disposed at a distance of λ/4 from the edge of the hole in the PCB. This distance may be set based on the leakage signal propagating from the round waveguide into the air gap, reaching the EBG structure, reflecting from the EBG structure with a phase change of 180 degrees, and entering back into the round waveguide, where it is in-phase added to the wave of the signal transmitted in the round waveguide. In this way, the signal (energy) is prevented from leaking outside and, therefore, interfering with the adjacent equipment, and the signal transmission loss through the rotary joint is reduced.

In one or more other embodiments, the EBG structure may be positioned close to the hole in the PCB.

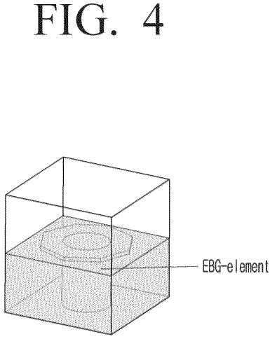

FIG. 4 shows a structure of an EBG element according to one or more embodiments. The aforementioned M-EBG elements are mushroom-shaped and are a pad (“mushroom cap”) located on the outer layer of the PCB, and a base (“mushroom leg”) in the form of a cylinder extending from the pad to the inner ground layer of the PCB. In the PCB, the base of the EBG element is formed by the via. For example, the pad may be round, square, triangular, hexagonal, etc. Size and shape of the pad affect boundaries of the band gap and may be set based on the requirements of a particular application. In one or more other embodiments, EBG elements may have more than one base.

In one or more embodiments, a choke is fastened to the stationary part of a rotary joint. Fastening options may include, but are not limited to, screws through a washer, special fixing plate, staples, glue, etc.

As depicted in FIG. 1, the choke is disposed in the air gap between the stationary and movable parts of the rotary joint parts at a certain distance. The gap between the choke and each of the stationary and movable part of the rotary joint may be in the range from 0 to λ/4, which may be defined by spacers.

In one or more embodiments, a choke may be positioned directly on a stationary or movable part of the rotary joint. In this example, outer conductive layer of the choke and conductive layer of the stationary (movable) part may or may not have electrical contact. Moreover, even when the outer layer of the choke is in contact or partially in contact with the surface of the stationary (movable) part, the EBG structure may be formed on a surface of the outer layer due to the fact that electrical contact is not guaranteed. In one or more embodiments, the choke, as described above, may have at least four conductive layers to form an EBG structure.

In one or more other embodiments, where electrical contact between the ground layer of the choke and the surface of one of the stationary and movable parts may be provided (e.g. by soldering these surfaces around the perimeter or over the entire area), the choke may have at least two conductive layers, and EBG structure in the choke is formed only on the side that is separated by an air gap from the surface of the other of the stationary and movable part.

The choke according to one or more embodiments may be robust to inaccuracies in the assembly of the rotary joint. For example, the choke may perform its functions and provide the advantages described above even when the choke is slightly offset from the rotation axis of the rotary joint or when it is skewed relative to the surface of the stationary part or movable part.

The signals described above may be either a data signal (information signal) for transmitting data through the rotary joint or a power signal for contactless power transmission through the rotary joint.

In one or more embodiments, data is transferred through the joint by millimeter radio waves. The millimeter wavelength range used provides data rates of up to several Gbps, while maintaining the relatively compact size of the waveguide. In one or more other embodiments, other suitable wavelength ranges may be used for signal transmission, depending on the data rate required.

Based on the contactless structure for transmitting signals between waveguides disposed on the stationary and movable parts, the joint may be capable of 360-degree rotation with no impact on signal transfer characteristics. In addition, the structure does not require additional shielding, which reduces the weight and material content of the structure.

In one or more embodiments, the waveguide of the joint movable part may be connected to the antenna unit, thereby forming a rotating antenna system. Such configuration may provide a relatively compact, lightweight, and reliable data and/or power transfer system for a rotating antenna system.

Mobility of the joint parts relative to each other may be ensured by placing a ball bearing between them. Moreover, the ball bearing may be replaced by any other suitable bearing or by an element that ensures the mutual arrangement of the joint parts in a given range and the ability of their rotation relative to each other.

Operation of a rotary joint configured to transfer a signal from transmitter in the stationary part of the rotary joint to receiver in the movable part will be further described in accordance with one or more embodiments.

First, for signal conversion to a linear polarized electromagnetic wave, an electromagnetic wave of dominant (fundamental) H₁₁ mode is excited in the round waveguide of the stationary part of the rotary joint. The H₁₁ mode is incident on the grooved polarizer at an angle of 45 degrees to the grooves. The polarizer transduces the electromagnetic wave of the dominant linear polarized H₁₁ mode into a circular polarized electromagnetic wave. The circular polarized electromagnetic wave propagates over the round waveguide, through the air gap, and enters the round waveguide of the movable part of the rotary joint. The choke in the air gap prevents the signal from leaking from the air gap outside of the rotary joint. Passing through the polarizer in the movable part of the rotary joint, the circular polarized electromagnetic wave is transduced to a linear polarized electromagnetic wave.

Although the above example describes operation of a rotary joint to transmit a signal from the stationary part of the rotary joint to the movable part, signal transmission in the opposite direction may be carried out in a similar manner.

Furthermore, due to transmission of the signal in the form of a circular polarized electromagnetic wave, the rotary joint may transmit signal at any angle of rotation of the movable part relative to the stationary part with the same efficiency. Moreover, a rotary joint in accordance with one or more embodiments may implement full-duplex communication.

Mathematical simulations have shown that a rotary joint in accordance with one or more embodiments provides a signal transmission reflection factor greater than or equal to 20 dB and a transmission loss less than or equal to 0.5 dB in the operating band. In addition, channel isolation greater than 15 dB is ensured.

Thus, one or more embodiments provides a relatively high-speed, contactless system for transmitting signals through a rotary joint, which has a relatively compact, reliable, simple, and inexpensive design.

The polarizer according to one or more embodiments may be used in a rotary joint for signal transmission.

According to another aspect of one or more embodiments, the polarizer may be used to form a circular polarized antenna device. The antenna device may include a waveguide with a polarizer according to one or more embodiments and an emission device, for example, such as a horn antenna. However, embodiments are not limited thereto. In addition to the horn antenna, other conventional types of antennas designed to emit a circular polarized wave may be used in the antenna device. The circular polarized antenna device may be used in both data transmission systems and wireless power transmission systems, such as wireless charging systems.

The antenna device may have a relatively compact, easy-to-manufacture, low loss and low-cost design.

While embodiments have been described with reference to the figures, it will be understood by those of ordinary skill in the art that various changes in form and details may be made therein without departing from the spirit and scope as defined by the following claims and their equivalents.

What is claimed is:

1. A system for contactless signal transmission through a rotary joint, comprising:
a transmitter on a first part of the rotary joint and a receiver on a second part of the rotary joint, the first part of the rotary joint and the second part of the rotary joint being opposite each other and separated by an air gap, a surface of the first part and a surface of the second part facing each other being perpendicular to a rotation axis of the rotary joint; and
a choke in the air gap between the first part of the rotary joint and the second part of the rotary joint and contacting one of the first part of the rotary joint and the second part of the rotary joint, the choke comprising a printed circuit board having a circular through hole coaxial with the rotation axis of the rotary joint, and an electromagnetic chip having an electromagnetic bandgap adjacent to the hole in the printed circuit board, the choke being configured to prevent signal leakage through the air gap,
wherein each of the transmitter and the receiver comprises a round hollow waveguide aligned with the rotation axis,
wherein at least the transmitter comprises in a waveguide polarizer which is a portion of the round hollow waveguide, a diameter of the waveguide polarizer being smaller than a diameter of the round hollow waveguide, and
wherein two longitudinal diametrically opposite grooves are formed in walls of the waveguide polarizer.

2. The system for contactless signal transmission of claim 1, wherein the length of the waveguide polarizer is a multiple of λ_{g}/2, where λ_{g} is a central wavelength of the signal operating range in the round hollow waveguide.

3. The system for contactless signal transmission of claim 1, wherein a bottom surface of the grooves coincides with inner walls of the round hollow waveguide.

4. The system for contactless signal transmission of claim 1, wherein the grooves extend along an entire length of the waveguide polarizer.

5. The system for contactless signal transmission of claim 1, wherein a diameter of the hole in the printed circuit board is equal to a diameter of the round hollow waveguide in the transmitter and the receiver.

6. The system for contactless signal transmission of claim 1, wherein a distance from the hole in the printed circuit board of the choke to the EBG structure is a multiple of λ/4, where λ is a central wavelength of the signal operating range in a plane-parallel waveguide formed based on surfaces of the first part and the second part and the choke.

7. The system for contactless signal transmission of claim 1, wherein the EBG structure is adjacent to the hole in the printed circuit board of the choke.

8. The system for contactless signal transmission of claim 1, wherein the EBG structure comprises at least two rows of mushroom-EBG (M-EBG) elements, each M-EBGs comprising a conductive pad on the outer layer of the printed circuit board, and a cylinder base formed by a metallized via and connecting the conductive pad to a conductive ground layer included in the printed circuit board.

9. The system for contactless signal transmission of claim 8, wherein the gap between the choke and each of the first part of the rotary joint and the second part of the rotary joint is less than or equal to λ/4, where λ is the central wavelength of the signal operating range in a plane-parallel waveguide formed based on the surfaces of first part and the second part and the choke.

10. The system for contactless signal transmission of claim 9, wherein the printed circuit board of the choke comprises four metallized conductive layers alternately disposed with dielectric layers, and
wherein the EBG structure is on both sides of the printed circuit board.

11. The system for contactless signal transmission of claim 10, wherein the M-EBG elements on opposite sides of the printed circuit board are interconnected by a via.

12. The system for contactless signal transmission of claim 8, wherein the choke is directly on one of the surfaces of the first part and the second part.

13. The system for contactless signal transmission of claim 12, wherein the printed circuit board of the choke comprises two metallized conductive layers with a dielectric layer between the two metallized conductive layers, and
wherein the EBG structure is on a side of the printed circuit board that is separated by the air gap from the surface of the other of the surfaces of the first part and the second part, based on electrical contact being provided between a ground layer of the choke and the surface of said one of the rotary joint parts.

14. The system for contactless signal transmission of claim 1, wherein the receiver comprises a waveguide polarizer in the round waveguide.

15. The system for contactless signal transmission of claim 1, wherein the signal is a data signal for data transmission through the rotary joint.

16. The system for contactless signal transmission of claim 1, wherein the signal is a power signal for contactless power transmission through the rotary joint.

17. The system for contactless signal transmission of claim 1, wherein the transmitter provides incidence of linear polarized waves on the polarizer at an angle of 45 degrees to the grooves of the polarizer.

18. A circular polarized antenna device comprising a waveguide with a waveguide polarizer, which is a section of a round hollow waveguide, having a smaller diameter than said waveguide and two longitudinal diametrically opposite grooves in walls of the polarizer and an emission device.

19. The antenna device of claim 18, wherein the emission device is a horn antenna.

20. The antenna device of claim 18, wherein the antenna device provides incidence of linear polarized waves on the polarizer at an angle of 45 degrees to the grooves of the polarizer.
